(19) United States
(12) Patent Application Publication
(10) Pub. No.: US 2013/0033773 A1
(43) Pub. Date: Feb. 7, 2013

(54) REFLECTOR HAVING HIGH RESISTANCE AGAINST WEATHER AND CORROSION EFFECTS AND METHOD FOR PRODUCING SAME

(71) Applicants: Frank Templin, Herdecke (DE); René Püschl, Schermbeck (DE); Harald Küster, Schwelm (DE)

(72) Inventors: Frank Templin, Herdecke (DE); René Püschl, Schermbeck (DE); Harald Küster, Schwelm (DE)

(21) Appl. No.: 13/638,347

(22) PCT Filed: May 19, 2010
(86) PCT No.: PCT/EP2010/056902

§ 371 Date: Oct. 15, 2012

(30) Foreign Application Priority Data
Apr. 1, 2010 (DE) 10 2010 013 865.7

(51) Int. Cl. G02B 5/08; B05D 5/06

(52) U.S. Cl. 359/838; 427/162

(57) ABSTRACT

The invention relates to a reflector (1) for electromagnetic radiation in the wavelength range of 100 nm to 1 mm, having high resistance against weather and corrosion effects, comprising a metal reflector body (2) having a reflecting surface (3), or a reflector body (2) on which a reflective layer (9) is deposited, and a transparent cover layer (4) made of polysiloxane formed in a sol-gel process. In order to maintain the known advantages of sol-gel protective coatings and achieve a technologically more advantageous production method, according to the invention, the cover layer (4) is made of a cross-linked polycondensate product of at least one silicic acid ester and at least one cyclic siloxane oligomer comprising, alkyl, vinyl, and/or aryl groups.

### BACKGROUND

1. Field of the Invention

The invention relates to a reflector for electromagnetic radiation in the wavelength range from 100 nm to 1 mm, with high resistance to effects of weathering and of corrosion.

The invention further relates to a process for producing a reflector of this type.

2. Related Technology

The production of transparent layers composed of polysiloxanes and formed in sol-gel processes, and into which nanoscale particles can also be bonded, is known. By way of example, the book “Nanotechnologie: Grundlagen and Anwendungen” [Nanotechnology: Principles and Applications] Hanover, Vincentz-Netzwerk, 2008, pages 102 to 106 by Stefan Sepeur describes the production of coating materials with good resistance to corrosion and to weathering. Said materials are obtained via polycondensation of organic, epoxy-functional resins, in particular of 3-glycidoxypropyltrimethoxysilane (GPTMS), with bisphenol A and 1-methylimidazole. However, the resistance of layers of that type to abrasion and to scratching is said to be frequently unsatisfactory.

DE 298 12 559 U1 describes a composite material with an aluminum substrate and an optically functional multilayer system applied thereto, on which, in turn, there is an external protective layer. Said protective layer can be composed of silicon dioxide or, in one embodiment, of a composition produced by using a sol-gel process and preferably made of an organically modified inorganic silicate network. The network can have been formed with use of hydrolyzable silanes, in particular siloxanes, which produce, via hydrolysis and condensation to give polysiloxane, with elimination of alcohol or water, a colloidal solution that can be applied as sol to the optical multilayer system. However, no specific formulation for producing the siloxane layer is given.

EP 1 287 389 B1 describes a reflector of the type mentioned in the introduction, in particular with a reflector body made of aluminum or of an aluminum alloy. The document mentioned says that it is well known that lustrous materials in strip form, e.g. high-purity aluminum, very high-purity aluminum, or AlMg alloys based on aluminum with a purity level of 99.5 percent or greater can be produced, where these provide diffuse or specular reflection of light, depending on the application. In this connection, it is also known that the surfaces of such strip materials can be polished chemically or electrolytically in order to increase specular reflection, and that anodic oxidation can then be used to produce a protective layer of thickness by way of example from 2 to 10 μm. A problem mentioned by EP 1 287 389 B1 here is that reflectors of this type often have restricted lifetime when exposed to outdoor weathering. Moisture in conjunction with UV radiation or CO₂, SO₂, or other pollutants leads to reduced reflectance values, and in particular to reduced gloss or reduced total reflection. The intention, with the subject matter described in the document mentioned, was therefore to provide a reflector of which the reflective side is resistant to weathering and to corrosion, and also resistant to mechanical influences, which can be cleaned effectively. The intention was that production be possible in a continuous manufacturing process. In the known reflector described for solving said problem, there is an external final transparent protective layer provided with a thickness of more than 1 μm, formed from a sol-gel coating material. The Ra roughness of the reflective surface of the reflector (determined in accordance with DIN 4761 to DIN 4768) is below 0.1 μm, and the sol-gel coating material was produced from a polysiloxane which was produced from an alcoholic silane solution and an aqueous colloidal silica solution. The reflector exhibits losses in total reflection and in gloss of less than 5 percent in a 2000-hour QUV test in accordance with ASTM G 53-96. However, it has been found that sol-gel coating materials of this type have only relatively low pot life, which is disadvantageous in industry.

The pot life is the time during which materials can be reliably used without problems. It is the time between the preparation of a mixture of a multicomponent substance and the end of its availability of use. The end of the pot life is mostly revealed by marked property changes, e.g. by a viscosity rise which prevents further use. Sol-gel systems, such as those described here, react immediately after hydrolysis, i.e. after addition of acid, and polymer formation therefore begins while the material is still in the open “pot”, i.e. in the reaction vessel.

It is an object of the invention to provide a reflector of the general type mentioned in the introduction, and a process for production thereof, where the reflector can be produced in a manner which is more technologically advantageous, with improvement of the known advantageous reflector properties, such as resistance to effects of weathering and of corrosion, resistance to mechanical effects, ease of cleaning, and the possibility of production in a continuous manufacturing process.

### SUMMARY

A reflector according to the principles of the present invention achieves said object in that the outer layer includes a crosslinked polycondensate of at least one silicic ester and of at least one cyclic siloxane oligomer comprising alkyl, vinyl, and/or aryl groups, or is formed in a process involving polycondensation of said reactants.

Silicic esters here are in particular the esters of orthosilicic acid having the general formula Si(OR)₄, where R in the molecule can be aryl and/or in particular alkyl groups. Said compounds are produced via reaction of silicon halides—e.g. silicon tetrachloride—with alcohols, e.g. methanol and ethanol. The reaction with methanol produces tetramethyl silicate, also termed tetramethyl orthosilicate—abbreviated to TMOS—in the form of colorless liquid. The reaction with ethanol produces tetraethyl silicate, also known as tetraethyl orthosilicate—abbreviated to TEOS. It has been found that in particular the last-mentioned compound has particular suitability, in combination with a cyclic siloxane oligomer comprising alkyl and/or aryl groups, for forming the outer layer of the reflector of the invention. It is preferable here that the number of monomer units bonded into the ring structure of the cyclic siloxane oligomer is not more than seven, preferably four. A monomer unit in the ring here is the smallest structural unit formed from any particular monomer. Preference is moreover given to the presence in the oligomer of from one to eight alkyl and/or vinyl groups, each of which preferably has from one to six carbon atoms. By this means it is possible during the condensation process to achieve ideal crosslinking conditions in the outer layer, and these can be used for adjustment to an ideal hardness-elasticity ratio.

In contrast to the restricted pot life of the known protective coating material of EP 1 287 389 B1, about 70 hours, pot life of more than 155 hours is possible in accordance with the invention with the coating materials which comprise the cyclic carbosiloxanes. These coating materials can be applied by various processes, such as casting, dip-coating, roll-application, spraying, doctoring, or spreading, continuously or—as in the case with spincoating—batchwise.

By virtue of the outer layer, extremely long life can be ensured for a reflector incorporating the principles of the present invention, and this is apparent by way of example in that even after 2000 hours, preferably indeed after 3000 hours, in the neutral salt spray mist test in accordance with DIN EN ISO 9227 NSS, the reflector exhibits no corrosion phenomena. Furthermore, the surface of the outer layer is easy to clean by conventional processes, for example using a soft brush and a stream of water, and is not damaged by use of standard cleaning processes of this type.

The reflector body can be composed of aluminum, magnesium, copper, titanium, molybdenum, tantalum, or steel, for example stainless steel, or of alloys with said substances, for example brass. There can be a base layer applied directly on the reflector body, in particular by a chromating, phosphating, anodizing, galvanizing, or similar, process. It is possible that, for cleaning, in particular for degreasing, the reflector body has been pretreated in advance by a method involving solution chemistry and/or by a method involving plasma chemistry.

Under the outer layer—directly on the reflector body or on the base layer—there can be a layer system with optical and/or mechanical function, in particular in the form of functional layer package. This type of layer package can advantageously have been applied in a continuous vacuum strip coating process.

By way of example, an optical layer system can be composed of two, three—or else more—layers, where at least the upper layer is a dielectric layer, and the undermost layer is a metallic layer which in particular is composed of aluminum and which forms the reflective layer. The material of the layers situated thereover can belong chemically to the group of the metal oxides, metal fluorides, metal nitrides, and metal sulfides, and mixtures of these, where the layers have different refractive indices. There can therefore be a difference between the refractive indices—based on a wavelength of 550 nm—which is by way of example greater than 0.10, preferably greater than 0.20.

The outer layer minimizes direct corrosive attack from the environment on the layers situated thereunder. The outer layer located on the reflector of the invention also features high regular solar transmittance, and a resultant advantage is that by way of example the desired optical properties of the functionalized layer package situated thereunder are also retained.

Excellent adhesion can be achieved, even with relatively high thicknesses of the outer layer, where this also has high elasticity and adequate hardness, if a dielectric layer situated directly under the outer layer is a titanium dioxide layer, in particular a titanium dioxide layer applied in a PVD process. Nb₂O₅ and Ta₂O₅, inter alia, are also recommended as an alternative in this connection.

It is preferable that a continuous vacuum coating process is used to apply the outer layer, and any other layers to be provided, to a metal strip as reflector body. The reflector of the invention can therefore be in coil format—in particular with width up to 1400 mm, preferably up to 1600 mm, and with thickness in the range of about 0.10 to 1.5 mm, preferably in the range from 0.3 to 1.0 mm. This type of reflector of the invention made of metal strip, base layer, functional layer package, and outer layer is deformable without impairment of optical, mechanical, and chemical properties.

Further advantageous embodiments of the invention are found in the detailed description below.

### BRIEF DESCRIPTION OF THE DRAWING

The principles of the invention are explained in more detail by using an embodiment illustrated by the attached drawing.

FIG. 1 here shows the principles of a cross section through a reflector embodying the principles of the invention.

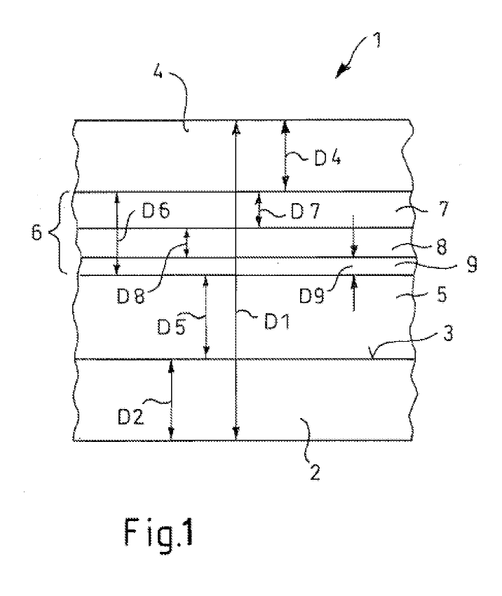

### DETAILED DESCRIPTION

The reflector 1 of the invention serves to reflect optical radiation—i.e. electromagnetic radiation in the wavelength range from 100 nm to 1 mm. In an embodiment as coil, the thickness D1 of the reflector 1 can be in the range of about 0.02 mm to 1.6 mm. The reflector 1 has a metallic reflector body 2, the surface 3 of which is reflective. As an alternative, there can also be a reflective layer 9 deposited on the reflector body 2, as also described in detail below.

The reflector body 2 can—as previously mentioned—be composed of aluminum, magnesium, copper, titanium, molybdenum, tantalum, chromium, nickel, or steel, for example stainless steel, or of alloys with said substances, for example of an AlMg alloy, or of brass. By way of example, the reflector body 2 can involve an Al 98.3 aluminum sheet in the form of a strip (purity 98.3 percent) with thickness D2 of 0.5 mm. The minimum thickness D2 of this type of sheet can be 20 μm, while the upper limit of a thickness D2 can be about 1.5 mm.

The reflector 1 has a transparent outer layer 4 composed of polysiloxane and formed in a sol-gel process. The thickness D4 of the outer layer 4 can be in the range from 0.5 to 40 μm, preferably in the range from 1 to 10 gm. It is moreover preferable that the arithmetic average roughness value Rₐ of the surface of the base layer 5 or of the reflector body 2—depending on the substrate to which the outer layer 4 is applied—is in the range below 0.05 μm, in particular below 0.01 μm, particularly preferably below 0.005 μm. It is possible here to achieve a total light reflectance of at least 95 percent, determined in accordance with DIN 5036, for the reflector 1 in accordance with the teachings of the present invention. It is moreover possible that the diffuse light reflectance determined in accordance with DIN 5036 is the range up to 95 percent.

The outer layer 4 in the invention is composed of a crosslinked condensate of at least one silicic ester and of at least one cyclic siloxane oligomer comprising alkyl, vinyl, and/or aryl groups. In this connection, specific formulations and possible production processes are also given below.

The other layers depicted in the drawing involve layers optionally present.

By way of example, it is possible to apply—directly on the reflector body 2—a base layer 5 produced by a chromating, phosphating, anodizing, galvanizing, or similar process. This type of base layer 5 can preferably be composed of anodically oxidized or electrolytically polished and anodically oxidized aluminum, formed from the material of the reflector body 2. It can be produced by a method involving solution chemistry, and in the final phase of the production chain here the pores of the aluminum oxide layer can be closed very substantially by a hot compaction process, thus producing a durably robust surface. The base layer 5 can also be composed of a plurality of sublayers. It can on the one hand serve as what is known as pretreatment layer with the function of promoting adhesion and smoothing the substrate for the layers situated thereover, but on the other hand it can also serve as electrochemical barrier layer or as layer with optical function. The minimal thickness D5 of the base layer 5 can be 1 nm, in particular 20 nm, preferably 50 nm, and particularly preferably 100 nm. The maximal thickness D5 of the base layer 5 is by way of example 5000 nm, preferably 1500 nm, and particularly preferably 300 nm.

Directly under the outer layer 4—as can be seen in the drawing—an optical layer system has been applied by way of example as functional layer package 6 to the reflector body 2. This type of layer system can be applied in a technologically advantageous manner by using a continuous vacuum strip coating process.

As depicted, this type of optical layer system can by way of example be composed at least of two layers 7, 8, and typically of three layers, 7, 8, 9, where the two upper layers 7, 8 are dielectric layers, and the undermost layer is a metallic layer which in particular is composed of aluminum and which, if the surface 3 of the reflector body 2 has not been provided for purposes of reflection, then forms a reflective layer 9. The respective optical thickness D7, D8 of the upper and of the middle layer 7, 8 of the optical layer system 6 should—in order that the layers 7, 8 can act as reflection-increasing interference layers—amount to about one quarter of the average wavelength of the spectral range of the electromagnetic radiation to be reflected.

However, a reflective layer 9 can also have been provided irrespective of the presence of one or more dielectric layers 7, 8 situated thereover. The metallic reflective layer 9 here can advantageously be a sputter layer or a layer produced by a vaporization process, in particular by electron bombardment or from thermal sources. The thickness D9 of the reflective layer 9 can be in the range from 10 nm to 200 nm. The layer 9 can be composed of aluminum, silver, copper, gold, chromium, nickel, and/or alloys of these, and can also have been formed from sublayers.

Reflective capability is increased if the uppermost layer 7 situated directly below the outer layer 4 in the functional layer package 6 is composed of a high-refractive-index material, such as Al₂O₃, ZrO₂, HfO₂, Nb₂O₅, Ta₂O₅, or preferably TiO₂, and the layer 8 situated thereunder is composed of a low-refractive-index material, such as SiO₂.

Particularly good adhesion of the outer layer 4 is achieved if the dielectric layer 7 situated directly below the outer layer 4 is a titanium dioxide layer applied in particular in a PVD process, since this type of layer is also a reactant in the condensation of the silicic ester and of the cyclic siloxane oligomer comprising alkyl, vinyl and/or aryl groups, and the bonding between the outer layer 4 and the dielectric layer 7 is therefore not only adhesive but also chemical, preferably via an interpenetrating network.

Specimens of three reflectors 1 in accordance with the teachings of the invention were produced for comparison with a comparative specimen. In each case, pot life and diffuse reflectivity in accordance with DIN 5036-3 were determined, and the wipe test in accordance with DIN ISO 9211-4 and the test known as the ΔT test were also carried out.

The usefulness of sol-gel coating materials for reflectors can be determined via the numerical ratio of diffuse reflection (rho-d) to total light reflection (rho) on flat specimens after processing has been completed (DIN 5036-3 “Radiometric and photometric properties of materials; methods of measurement for photometric and spectral radiometric characteristics”). The determination method was as follows. Directly after production of the sol-gel coating materials, in a cycle of multiples of 24 hours, a coating process was carried out on an anodized aluminum sheet made of the alloy EN AW 1085 in accordance with the standard EN 573-3 (Al 99.85), by dip-coating with about 3 μm dry thickness and 3 minutes of hardening at 200° C. After hardening of the coating and cooling of the specimen to room temperature, the reflectivities for total light reflection (rho) and for diffuse reflection (rho-d) were determined with the aid of an Ulbricht sphere. While there is no change in total light reflection (rho), diffuse reflection for the coated specimen rises, depending on the aging time and the sol-gel coating material. Haze is visible in the coating when the quotient calculated from rho-d and rho exceeds the value 0.20.

The ΔT test is carried out by a method based on DIN 50 928 Section 9.5. A circular specimen with diameter 118 mm is fixed in a holder. The frontal side of the specimen is flushed with water at 42° C., with the aid of pumps, while the reverse side is exposed to water at 35° C. The exposure time is 168 hours. After the exposure, a visual check determines whether adhesion of coating material has been lost.

Tesa peel tests are moreover carried out with and without crosscut in accordance with DIN 2409. An assessment is made here as to whether areas of loss of adhesion occur, or whether the Tesa peel test results in loss of adhesion of the crosscut.

### COMPARATIVE EXAMPLE

10 ml of 3-glycidoxypropyltrimethoxysilane (GPTMS) were hydrolyzed by adding 1.222 ml of 0.1 molar hydrochloric acid and stirring for one hour at room temperature. 2.95 g of bisphenol A were then dissolved in the resultant GPTMS sol, and 7.02 ml of Nanopol® C 764 dispersion were added.

Nanopol® C products are colloidal silica sols in solvents, and are produced by nanoresins AG, Geesthacht. These products have low viscosity and exhibit no sedimentation at all, i.e. processability remains substantially unchanged in comparison with the respective underlying resin. The nanoparticles are produced in a modified sol-gel process. The disperse phase of Nanopol® C is composed of spherical, surface-modified SiO₂ nanoparticles with average diameter 20 nm and with extremely narrow particle size distribution (about ±10 nm). Nanopol® C 764 comprises 50 percent by mass of SiO₂ nanoparticles dispersed in methoxypropyl acetate, and its dynamic viscosity at 25° C. is 20 mPa*s.

160 μl of methylimidazole per 10 ml of GPTMS were added as polycondensation catalyst.

The resultant coating material was applied by dip-coating to a substrate. An anodized aluminum sheet specified as EN AW 1085 in accordance with the standard EN 573-3 (Al 99.85) was used as substrate or as reflector body 1 for all of the examples. In each case there was therefore a base Al₂O₃ layer 5, which in particular can have a thickness of 2 μm, located on the reflector body 2.

Drying and curing then took place at 200° C. in a heating tunnel for a period in the range from 5 to 10 minutes.

Layer thicknesses thus achievable for the outer layer were in the range of 4.1±3.4 μm, and the diffuse reflectivity rho-d determined here in accordance with DIN 5036-3 was 13.8 percent. Although the wipe test in accordance with DIN ISO 9211-4 was passed (50 H-1), the ΔT test indicated failure of the reflector. Delamination of the outer layer could be discerned.

### FIRST EXAMPLE

0.745 g of a cyclic polysiloxane of the chemical formula cyclo-{SiO(CH₃)[CH₂CH₂Si(CH₃)(OC₂H₅)₂]}₄ was reacted at room temperature with 14.7 g of tetraethoxysilane (TEOS) in an alcoholic solution made of 7.7 g of ethanol and 23.2 g of 2-butanol, with addition of 2.4 ml of 0.1 molar hydrochloric acid and stirring for 30 minutes, and with further addition of 2.4 ml of 0.1 molar hydrochloric acid with stirring for 60 minutes, and with final addition of 1.2 ml of 2.5 percent acetic acid with stirring for 60 minutes.

The resultant coating material was applied via dip-coating to a reflector body 2.

Drying and hardening then followed in a heating tunnel at 200° C. for a period in the range from 5 to 7 minutes, thus forming the outer layer 4. A three-dimensional organosiloxane network is formed here as gel, and the cyclic component in this in particular increases flexibility.

This method could achieve layer thicknesses D4 in the range of 1.5±0.4 μm for the outer layer 4. The roughness values were 5.3±0.3 nm for the arithmetic average roughness value Rₐ and 38.3±3.0 nm for the average roughness R_{z}, and the diffuse reflectivity determined in accordance with DIN 5036-3 was 8.5 percent. Both the wipe test in accordance with DIN ISO 9211-4 (50 H-1) and the ΔT test were passed. No delamination of the outer layer 4 could be discerned.

### SECOND EXAMPLE

14.4 ml of methacryloxypropyltrimethoxysilane (MAOPTMS) were converted to an alcoholic solution with 10.8 ml of tetraethoxysilane (TEOS) and 5.4 ml of 1,3,5,7-tetra-vinyl-1,3,5,7-tetramethylcyclotetrasiloxane (VINYL-D4) by adding 26.6 ml of isopropanol. 4.5 ml of demineralized water with 22 μl of 85 percent phosphoric acid were then added dropwise, with stirring. Stirring for six hours then brought about hydrolysis.

Finally, 1 percent by volume of di-tert-butyl peroxide and TEGO® Glide 410 were added.

TEGO® Glide 410 involves a polyether-siloxane copolymer which is marketed as slip and levelling additive by Evonik Tego Chemie GmbH, Essen in the form of liquid with non-volatile content of about 92 percent by mass and with dynamic viscosity about 2000 mPa*s at 25° C. This additive adjusts the surface tension of a drying coating material to a uniform low level. It thereby levels differences in surface tension, thus minimizes flow of material from regions with low surface tension to regions with higher surface tension, and suppresses turbulence. The film of coating material dries very homogeneously and thus exhibits substantially better leveling, which in accordance with DIN 55945 means the property of coating materials to provide spontaneous equalization of unevenness resulting from spray mist, brush strokes, etc., after application.

The resultant coating material was applied via dip-coating to a reflector body 2. Drying and hardening then followed in a heating tunnel at 200° C. for a period in the region of about 5 minutes, thus forming the outer layer 4. It was also possible here to use irradiation with UV light in order to achieve a higher degree of crosslinking, prior to or after the thermal curing process.

Layer thicknesses thus achievable for the outer layer 4 were in the range of 2.2±0.3 μm, and the diffuse reflectivity determined here in accordance with DIN 5036-3 was 13.9 percent. Both the wipe test in accordance with DIN ISO 9211-4 (50 H-1) and the ΔT test were passed. No delamination of the outer layer 4 could be discerned

Advantageous drying times, depending on the composition and thickness D4 of the outer layer 4, have been found to be in the range from 1 min to 60 min, preferably in the range from 3 min to 5 min. A preferred treatment temperature is considered to be one in the range from 150° C. to 300° C., ideally in the range from 180° C. to 250° C.

### THIRD EXAMPLE

60.0 ml of methacryloxypropyltrimethoxysilane (MAOPTMS) were converted to an alcoholic solution with 10.0 ml of tetraethoxysilane (TEOS) and 10.0 ml of 1,3,5,7-tetra-vinyl-1,3,5,7-tetramethylcyclotetrasiloxane (VINYL-D4) by adding 50.0 ml of isopropanol. From 1 to 2 ml of 0.1 molar hydrochloric acid were then added, for hydrolysis, with stirring. A further twelve hours of stirring then brought about hydrolysis.

Finally, 1 percent by volume of a photoinitiator was added (e.g. an α-hydroxyketone, such as Irgacure® 184 or Irgacure® 1173 from Ciba). It was then possible to carry out crosslinking by UV light, by means of a mercury source, in order to form the outer layer 4. The throughput velocity here can be in the range of about 10 to 25 m/min for a UV dose in the range from 100 mJ/cm² to 500 mJ/cm².

For the outer layer 4, this method can achieve thicknesses D4 in the range of 2.5±0.4 μm and diffuse reflectivities in accordance with DIN 5036-3 in the range from 8.2 to 12.7 percent. The wipe test in accordance with DIN ISO 9211-4 (50 H-1) and the ΔT test were passed.

When the reflectors 1 in accordance with the teachings of the invention were compared with the comparative example, almost identical optical properties were discerned, with substantially better corrosion resistance values. When these were measured in the invention—taking the frequency of surface defects occurring in the salt spray mist test in accordance with DIN EN ISO 9227 NSS—they were above 2000 h and thus about twice as high as for the comparative example and also for a reflector as in EP 1 287 389 B1. This corresponds to a lifetime of more than twelve months in external weathering—open-air weathering in a Mediterranean coastal climate.

The pot life determined for the “first example” by the method described above for determining processability was about 300 hours. In contrast to this, the pot life determined for the known protective coating material as in EP 1 287 389 B1 was only at most about 70 hours, and the producer here states that the material can be used for 48 hours after production.

In order to provide even greater certainty of suppression of visual haze, the quotient calculated from rho-d (diffuse reflection) and rho (total reflection) should not exceed the value 0.15. On this basis, the pot life defined by the “first example” was about 155 hours, whereas in the case of the protective coating material known from EP 1 287 389 B1 the value of 0.15 was likewise reached after only 70 hours. The “comparative example” also only achieved values below 90 hours.

The present invention is not restricted to the inventive example depicted, but encompasses all of the means and measures having equivalent effect for the purposes of the invention. By way of example, it is therefore also possible to form the outer layer 4 by using silicic esters which have a general formula other than the abovementioned formula Si(OR)₄, in which R is an aryl or alkyl group. By way of example here, other groups can replace one or more of the OR groups, as is the case with GPTMS or MAOPTMS.

As already mentioned, it is possible to use, in the rings of the cyclic siloxanes, not only the monomer units of the inventive examples —SiO(CH₃)[CH₂CH₂Si(CH₃)(OC₂H₅)₂]— and —SiO(CH₃)— but also other monomer units—and also with another number in the ring.

The person skilled in the art can moreover supplement the teachings of the invention through additional advantageous measures, without exceeding the scope of the invention. By way of example, the coating material formulation should ideally always be brought into contact with a surface 3 of constant surface energy. To this end, there is a variety of possibilities, alongside the use described of a levelling agent, for creating reproducible conditions by using suitable processes. By way of example, the reflector body 2 can, prior to the application process, be activated for example by flame pyrolysis, corona treatment, or plasma treatment, or a combination thereof, in order to achieve constant free surface energy of the strip. Cooling or heating of the reflector body 2 can moreover take place prior to and/or during and/or after the application of the outer layer 4 and/or the drying process.

The drying and curing of the coating material of the outer layer 4 after the application process can—as already apparent from the descriptions above—take place via various types of energy input—depending inter alia on the specific embodiment of the coating material, for example via absorption of visible radiation, which may be poly- or monochromatic, for example by means of laser, and/or via conduction of heat, convection, or electron beams, and/or via inductive heating of the reflector body 2, and/or via electromagnetic radiation outside of the visible spectrum. Specific modifications of environmental conditions can be implemented upstream and/or downstream, for example humidity, inertization, or sub- or superatmospheric pressure. The entire drying/crosslinking process can also take place in inert atmospheres.

All of the conditions stated by way of example can be scaled up to pilot-plant scale without difficulty.

The invention is moreover not restricted to the feature combinations specifically defined in specification or claims, but can also be defined via any other desired combination of particular features from the entirety of individual features disclosed herein. This means that in principle practically any individual feature can be omitted and, respectively, replaced by at least one individual feature disclosed at another point in the specification.

### REFERENCE KEY

1 Reflector
2 Reflector body of 1
3 Surface of 2
4 Outer layer
5 Base layer
6 Functional layer package, specifically optical layer system
7 Uppermost layer of 6
8 Middle layer of 6
9 Undermost layer of 6, reflective layer
D1 Thickness of 1
D2 Thickness of 2
D4 Thickness of 4
D5 Thickness of 5
D6 Thickness of 6
D7 Thickness of 7
D8 Thickness of 8
D9 Thickness of 9

What is claimed is:

1. A reflector for electromagnetic radiation in the wavelength range from 100 nm to 1 mm, with high resistance to effects of weathering and of corrosion, comprising:
a metallic reflector body which has a reflective surface, and a transparent outer layer (4) composed of polysiloxane and formed in a sol-gel process, the outer layer being formed of a crosslinked polycondensate of at least one silicic ester and of at least one cyclic siloxane oligomer comprising at least one of an alkyl, vinyl, and aryl group.

2. The reflector as claimed in claim 1, wherein the silicic ester is an ester of orthosilicic acid having the general formula Si(OR)₄, where R is an aryl and/or in particular alkyl group.

3. The reflector as claimed in claim 1, wherein the silicic ester is tetraethyl orthosilicate (TEOS).

4. The reflector as claimed in claim 1, wherein monomer units bonded into the ring structure of the siloxane oligomer is not more than seven.

5. The reflector (1) as claimed in claim 1, wherein the siloxane oligomer includes from one to eight alkyl and/or vinyl groups, each of which has from one to six carbon atoms.

6. The reflector as claimed in claim 1, wherein the siloxane oligomer is a compound having the chemical formula
cyclo-{SiO(CH₃)[CH₂CH₂Si(CH₃)(OC₂H₅)₂]}₄ or
cyclo-[SiO(CH₃)(CHCH₂)]₄ or is
1,3,5,7-tetravinyl-1,3,5,7-tetramethylcyclotetrasiloxane.

7. The reflector as claimed in claim 1, wherein the reflector body is aluminum, magnesium, copper, titanium, molybdenum, tantalum, steel, stainless steel, or alloys thereof.

8. The reflector as claimed in claim 1, further comprising a base layer provided directly on the reflector body by a chromating, phosphating, anodizing, galvanizing, or similar, process and the reflective surface being located between the base layer and the outer layer.

9. The reflector as claimed in claim 8, wherein the base layer has a thickness in the range of 1 nm to 5000 nm.

10. The reflector as claimed in claim 1, wherein the reflector body is pretreated by a method involving solution chemistry or by a method involving plasma chemistry to clean or degrease the reflector body prior to the providing of the outer layer thereon.

11. The reflector as claimed in claim 1, wherein a functional layer package with at least one of an optical and mechanical function is provided between the outer layer and the reflector body.

12. The reflector as claimed in claim 11, wherein the functional layer package is an optical layer system.

13. The reflector as claimed in claim 12, wherein the optical layer system has at least three layers, and two of the at least three layers are dielectric layers positioned toward the outer layer and another of the at least three layers is a metallic layer positioned toward the reflector body and which is formed of aluminum and which forms the reflective layer.

14. The reflector as claimed in claim 13, wherein the metallic layer of the optical layer system is a sputter layer or a layer produced by a vaporization process, in particular by electron bombardment or from thermal sources.

15. The reflector as claimed in claim 13, wherein the dielectric layers of the optical layer system belongs chemically to the group of the metal oxides, metal fluorides, metal nitrides, and metal sulfides, and mixtures of these, and have different refractive indices.

16. The reflector as claimed in claim 1, wherein one of the dielectric layers is directly adjacent to the outer layer in the optical layer system and is composed of a high-refractive-index material from the group consisting of Al₂O₃, ZrO₂, HfO₂, Nb₂O₅, Ta₂O₅, and TiO₂, and the other of the dielectric layers is composed of a low-refractive-index material.

17. The reflector as claimed in claim 13, wherein the dielectric layers of the optical layer system are sputter layers or PVD layers or PECVD layers, or layers produced by a vaporization process.

18. The reflector as claimed in claim 1, wherein the outer layer is a cured outer layer having been cured in one or more stages with exposure to heat, with UV and/or IR radiation from lamps, or lasers, or with electron beams, and/or with hot air.

19. The reflector as claimed in claim 1, wherein the outer layer has a thickness in the range from 0.5 to 40 μm.

20. The reflector as claimed in claim 9, wherein an arithmetic average roughness value (Rₐ) of the surface of the base layer is less than 0.05 μm.

21. The reflector as claimed in claim 1, wherein total light reflectance determined in accordance with DIN 5036 is at least 95 percent.

22. The reflector as claimed in claim 1, wherein diffuse light reflectance determined in accordance with DIN 5036 is in the range up to 95 percent.

23. The reflector as claimed in claim 1, wherein mechanical resistance of the surface of the reflector determined in accordance with DIN 58196 is greater than H 50-1.

24. The reflector as claimed in claim 1, wherein the reflector body is provided in a coil format with width up to 1400 mm and with thickness (D1) in the range of about 0.10 to 1.60 mm.

25. A process for producing a reflector for electromagnetic radiation in the wavelength range from 100 nm to 1 mm, with high resistance to effects of weathering and corrosion, comprising the steps of:
providing one of a metallic reflector body having a reflective surface or a reflector body on which a reflective layer has been deposited, and providing as an outer layer over the reflective surface a transparent layer formed from polysiloxane in a sol-gel process, the outer layer being produced by crosslinking polycondensation from at least one silicic ester and from at least one cyclic siloxane oligomer comprising alkyl, vinyl, and/or aryl groups.

26. The process as claimed in claim 25, wherein the silicic ester is one of an ester of tetraethyl orthosilicate and an ester of orthosilicic acid having the general formula Si(OR)₄, where R is an aryl or alkyl group, and the cyclic siloxane oligomer is one of a siloxane oligomer having not more than sever monomer units bonded into its ring structure, a siloxane oligomer having from one to eight alkyl and vinyl groups each with one to six carbon atoms, and a siloxane oligomer that is a compound having the chemical formula of
cyclo-{SiO(CH₃)[CH₂CH₂Si(CH₃)(OC₂H₅)]}₄ or
cyclo-[SiO(CH₃)(CHCH₂)]₄ or is
1,3,5,7-tetravinyl-1,3,5,7-tetramethylcyclotetrasiloxane.

27. The process as claimed in claim 26, wherein the silicic ester and the cyclic siloxane oligomer comprising alkyl, vinyl, and/or aryl groups are reacted with one another in an organic solvent being a ketone or alcohol.

28. The process as claimed in claim 26, wherein the silicic ester and the cyclic siloxane oligomer comprising alkyl, vinyl, and/or aryl groups are decomposed hydrolytically by at least one acid.

29. The process as claimed in claim 25, wherein the outer layer is formed, by drying and hardening, from the polycondensation reactants initially applied as coating material to the reflector body, where energy is introduced via absorption of poly- or monochromatic optical radiation, or by electromagnetic radiation outside of the visible spectrum.

30. The process as claimed in claim 29, wherein the drying and hardening is carried out in a heating tunnel with drying times in the range from 1 min to 60 min and with a treatment temperature in the range from 150° C. to 300° C.

31. The process as claimed in claim 25, wherein all of the steps in the process are performed in a continuous sequence in a roll-to-roll manufacturing process.

32. The reflector as claimed in claim 1, wherein the reflective surface is defined by a reflective layer on the reflective body.

33. The reflector as claimed in claim 1, wherein an arithmetic average roughness value (Rₐ) of the surface of the reflector body is less than 0.05 μm.
